(19) United States
(12) Patent Application Publication
(10) Pub. No.: US 2002/0090278 A1
(43) Pub. Date: Jul. 11, 2002

(54) SELF DRILLING SCREW STRUCTURE

(75) Inventor: Tsung-Cheng Lai, Kaohsiung Hsien (TW)

Correspondence Address: Bacon & Thomas, 4th Floor, 625 Slaters Lane, Alexandria, VA, 22314, US

(73) Assignee: Hsiao Kang Shan Screw Co., Ltd., Kaohsiung Hsin (TW)

(21) Appl. No.: 09/754,303

(22) Filed: Jan. 5, 2001

(51) Int. Cl. F16B 25/10

(52) U.S. Cl. 411/387.8

(57) ABSTRACT

A self-tapping screw structure includes a threaded rod having one end provided with a cap head, and the other end of the threaded rod is formed with two blades respectively located at two sides of the central point of the threaded rod. Each of the two blades has an extended scrap escaping groove. One of the two blades is provided with a slow cutting portion located adjacent to the central point of the threaded rod and lower than the surface of the second blade, thereby greatly increasing the tapping velocity of self-tapping screw structure.

### BACKGROUND OF THE INVENTION

1. Field of the Invention

The present invention relates to a self-tapping screw structure for increasing the tapping speed thereof, and more particularly to a self-tapping screw structure whose tapping velocity can be accelerated, and which can save energy during use.

2. Description of the Related Prior Art

The closest prior art of which the applicant is aware is disclosed in the Taiwanese Patent Publication No. 340584, entitled by “Self-Tapping Screw Especially used for a Corrugated Board”, which discloses a self-tapping screw including a head integrally formed with a threaded rod. The threaded rod has one end axially provided with a blade which is provided with a first thread and a second thread toward the direction of the head. The threading pitch and threading depth of the first thread are smaller that of the second thread.

In addition, another prior art of which the applicant is aware is disclosed in the Taiwanese Patent Publication No. 348820, entitled by “Self-Tapping Screw Structure Improvement”, which discloses a self-tapping screw including a body having an upper portion provided with screw head and a lower portion provided with end head having a scrap draining recess.

In the Taiwanese Patent Publication No. 340584, two blades are mounted on the center of the threaded rod symmetrically. In the Taiwanese Patent Publication No. 348820, there is provided with a helical oblique thread having a polygonal face with a sharp edge. In general, the conventional self-tapping screw is usually used for tapping a metallic corrugated board, and when the conventional self-tapping screw taps initially, at least two blades are in contact with the metallic corrugated board, thereby greatly affecting and lowering the cutting velocity of the initial tapping. Therefore, the blade may be provided with a leading oblique angle and scrap escaping angle for increasing the cutting velocity of the conventional self-tapping screw. However, when the leading oblique angle of the blade is too large, this will decrease the strength of the blade, so that the blade is easily broken or worn out during the tapping and cutting process. In addition, a heat treatment for processing the conventional self-tapping screw easily fails.

### SUMMARY OF THE INVENTION

The primary objective of the present invention is to provide a self-tapping screw structure, wherein the self-tapping screw structure can increase the cutting velocity efficiently without breaking the strength of the blade.

In accordance with the present invention, there is provided a self-tapping screw structure includes a threaded rod having one end provided with a cap head, and the other end of the threaded rod is formed with two blades respectively located at two sides of the central point of the threaded rod. Each of the two blades has an extended scrap escaping groove. One of the two blades is provided with a slow cutting portion located adjacent to the central point of the threaded rod and lower than the surface of the second blade, thereby greatly increasing the tapping velocity of self-tapping screw structure.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a self-tapping screw structure in accordance with the present invention;

FIG. 2 is a front view of the self-tapping screw structure as shown in FIG. 1;

FIG. 3 is a locally enlarged view of the self-tapping screw structure as shown in FIG. 2; and

FIG. 4 is a bottom plan view of the self-tapping screw structure along the line 4-4 as shown in FIG. 3.

### DETAILED DESCRIPTION OF THE PREFERRED EMBODIMENTS

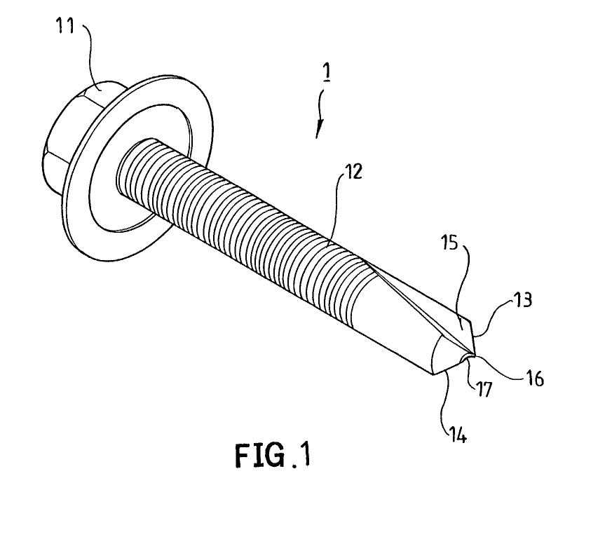

Referring to the drawings and initially to FIG. 1, a self-tapping screw structure 1 in accordance with the present invention primary comprises a threaded rod 12 having one end provided with a cap head 11, and the other end of the threaded rod 12 is formed with two blades 13 and 14. Each of the two blades 13 and 14 is extended with a scrap escaping groove 15.

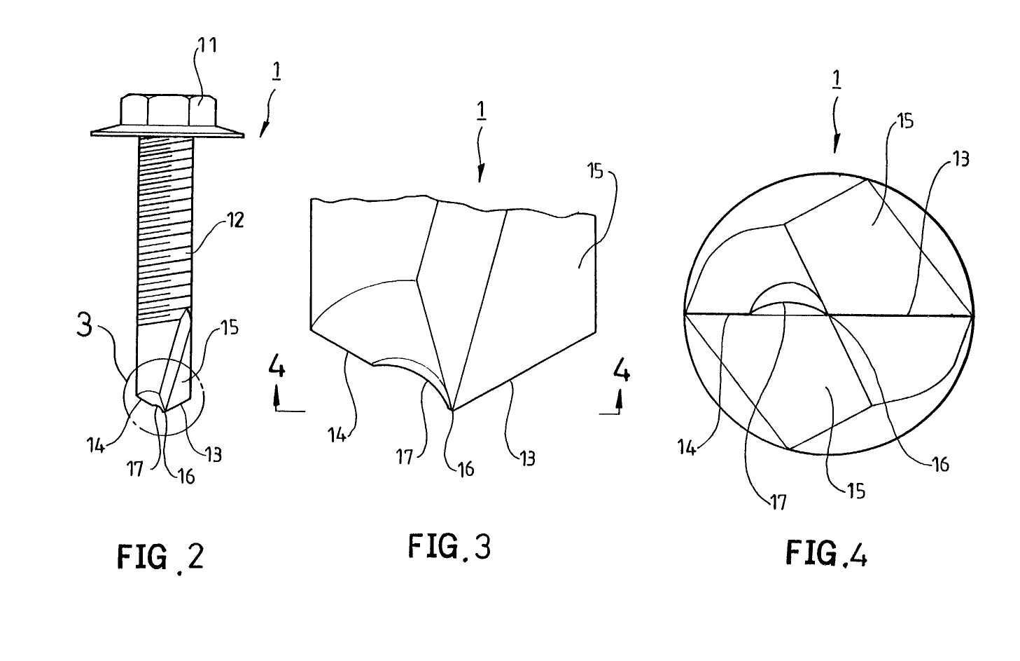

Referring to FIGS. 2-4, the two blades 13 and 14 respectively extend from the central point 16 of the threaded rod 12 toward the two sides of the threaded rod 12, to form a first blade 13 and a second blade 14 respectively. The second blade 14 is provided with a slow cutting portion 17 located adjacent to the central point 16 of the threaded rod 12 and lower than the surface of the second blade 14. The slow cutting portion 17 of the second blade 14 may be a breach or different inclination, so that when the self-tapping screw structure 1 is rotated about the central point 16 to tap into a workpiece, the slow cutting portion 16 cannot cut a metallic plate. Therefore, when the self-tapping screw structure 1 of the present invention initially taps, only the first blade 13 located at one side of the central point 16 first taps into and cuts the metallic plate, while the second blade 14, due to provision of the slow cutting portion 17, is not in contact with the metallic plate during the initial tapping action, thereby decreasing friction. Therefore, the self-tapping screw structure 1 can be tapped into the metallic plate with a greater velocity, thereby enhancing the cutting and tapping velocity.

Accordingly, the construction of the present invention primarily provides a slow cutting portion on the initial tapping blade of the self-tapping screw structure. Therefore, when the self-tapping screw structure initially taps, the contact of the blade with the metallic plate reduces the friction and limit of the slow cutting portion, and thus also increases the cutting amount, thereby achieving rapid cutting and energy saving purposes. In addition, the strength of the blade of the self-tapping screw structure of the present invention will not be changed.

Although the invention has been explained in relation to its preferred embodiment as mentioned above, it is to be understood that many other possible modifications and variations can be made without departing from the scope of the present invention. It is, therefore, contemplated that the appended claim(s) will cover such modifications and variations that fall within the true scope of the invention.

What is claimed is:

1. A self-tapping screw structure comprising: a threaded rod having one end provided with a cap head, and the other end of the threaded rod formed with two blades, the two blades respectively located at two sides of a central point of the threaded rod, to form a first blade and a second blade respectively, each of the first blade and the second blade having a scrap escaping groove, wherein, the second blade is provided with a slow cutting portion located adjacent to the central point of the threaded rod and lower than a surface of the second blade.

2. The self-tapping screw structure as claimed in claim 1, wherein the slow cutting portion of the second blade may be a breach or different inclination.
